(19) United States
(12) Patent Application Publication
(10) Pub. No.: US 2011/0078375 A1
(43) Pub. Date: Mar. 31, 2011

(54) DATA STORAGE

(76) Inventors: Keir Shepherd, Bristol (GB); Neil MacDougall, Bristol (GB); Ben Wynne, San Diego, CA (US); Lon Barfield, Bristol (GB)

(21) Appl. No.: 12/570,302

(22) Filed: Sep. 30, 2009

(51) Int. Cl. G06F 12/00; G06F 12/08

(52) U.S. Cl. 711/115; 711/118; 711/E12.001; 711/E12.017

(57) ABSTRACT

A method and device for executing data access and storage using a host device, the method comprising providing a removable device for the host operable to effect communication between the host and a remote storage service, wherein the removable device is operable to cache data received from and sent to the storage service, the removable device further operable to effect communication between the host device and the storage service using a wireless communication module.

### BACKGROUND

The volume and movement of data worldwide continues to grow and is driven by, amongst other factors, the increasing number of devices which are able to author and consume content. A user's need for the storage of this content is not just defined by volume but also by accessibility. Content can become significantly more valuable when it can be transferred and accessed seamlessly across multiple devices. ‘Cloud’ based storage services as part of a cloud computing paradigm can be used to store and access such content. In general, cloud computing is a style of computing in which dynamic, scalable, virtualized computing resources are provided to users, usually over the Internet.

### BRIEF DESCRIPTION OF THE DRAWINGS

Various features and advantages of the present disclosure will be apparent from the detailed description which follows, taken in conjunction with the accompanying drawings, which together illustrate, by way of example only, features of the present disclosure, and wherein:

FIG. 1 is a schematic representation of software components associated with a system as described herein; and

FIG. 2 is a schematic representation of hardware components for a system as described herein.

### DETAILED DESCRIPTION

According to an embodiment, there is provided a system for allowing users, through any host device, secure access to storage space. According to a preferred embodiment, access is provided on devices which support the Universal Serial Bus (USB) standard. Alternatively, as will be explained below, access can be effected using, for example, a storage card slot of the device such as a flash storage card reader/writer for use with SD and/or CF storage cards for example. Other alternatives are possible.

According to a preferred embodiment, the system can take the form of a USB ‘memory stick’, which can comprise on-board memory, such as flash memory, and processing capability. The storage is provided by a cloud-based storage service and can be accessed by a wireless networking capability within the device, rather than relying on connectivity of the host. Such an approach allows the cloud based storage to be accessed by both PC and non-PC devices, including printers, TV's, digital photo frames and cameras for example. That is to say, the provision of processing capability on the USB stick, or other suitable device, provides a system in which ‘dumb’ devices can be access, retrieve, and act as a conduit for storage of data in a cloud storage service. For the sake of clarity, the remainder of this description will refer only to a system using a USB device, such as a USB memory stick. This is not intended to be limiting, and the system as described can be instantiated using other suitable devices as will be apparent to those skilled in the art.

Herein, the term ‘cloud storage’ will be used to refer to the provision of server-based data storage which can be remotely accessed seamlessly and transparently by a client at any time using a host device which can connect to the internet. According to an embodiment, internet connectivity of a host device is effected using the USB device, so that the host need not have any networking or processing capability built-in.

According to an embodiment, a suitable device can provide caching and processing capability such that a user is unaware, from a file access point of view, where a local cache ends and cloud storage begins. The device will appear to have the same behaviour and characteristics as, for example, a standard USB memory stick. Of course, performance for data reads of non-cached items will be subject to the limitations of the chosen network connection technology. According to a preferred embodiment, a connection to a cloud storage service is preferably made using a direct connection to the Internet using Wi-Fi for example. Alternatively, a connection to the Internet, and the storage service, can be made using a cellular telephone network connection. For example, the device can include the necessary functionality to send and receive data using any one or more of a 3G, GPRS or EDGE data cellular network for example. Other alternatives are possible, and the connection options listed above are not intended to be limiting.

According to an embodiment, the device can be presented in the form of a USB memory stick, since this is a form that is very familiar to, and well understood by users. Users can simply plug the USB device in to their devices (cameras, PCs, photo frames, televisions etc) as with existing USB memory sticks where the appropriate connection exists. By using a USB stick form factor and interface, with its own connectivity and processing capability and presenting the cloud storage as a transparent and cached file system the concept of cloud based storage can be made palatable to both consumer and enterprise audiences.

According to an embodiment, the USB stick can be deactivated, in the cases of loss or theft, by the service thus ensuring that sensitive material is not available outside the intended audience. Through the use of manual intervention or policy rule sets, resources (folders and files for example) which reside on the storage (cached locally or in the cloud) can be tagged with security control metadata. This security control metadata will determine the level of authorisation required to access a particular resource. Such metadata can specify a range of authorisation policies from “always check for authorisation with central authority” to “always allow access” for example. Where resources have been tagged with security metadata indicating that authorisation must be obtained from a central authority, a system administrator can have the ability to revoke access to one or a group of USB sticks, users or resources. This capability is especially useful where sensitive data is stored on a stick which subsequently becomes lost or is stolen. Authorisation policies may also take into account location (where location hardware is available) allowing system administrators to define locality and proximity authorisation rules such as “only allow access in a particular office/location” or “only allow access within X meters of a security beacon” for example.

Accordingly, the system according to an embodiment has the following key attributes:
Flash storage on a USB Stick acts as a transparent cache for cloud storage of data. Intelligent management of the cache, which can be performed on the stick itself rather than the host, ensures that bottlenecks can be overcome. In particular by caching directory structures, file properties and headers for example, the tendency for USB hosts to scan all files and folders after a USB stick is inserted will not lead to long delays. Only when data from a file is required will the content be retrieved from the network and then only in cases where the data itself is not cached locally. The caching implementation is analogous to a reverse proxy, where users of the data are given a single URI (in this case a file system path) and the device (USB stick) determines, based on the caching policy, if the requested data can and should be accessed from the local copy or obtained from a central store. Where data is accessed from a central store the USB stick (again analogous to a reverse proxy) makes the request on behalf of the user, caches the data locally and returns the data as a stream or whole data block.
The USB Stick can have its own connectivity, such as wireless connectivity for example. Whilst this adds cost to the stick (which can be offset by subscription to the service for example) it means that the stick need not make assumptions about the capabilities of the host and can therefore be used by non-PC devices, such as printers, TV's, photo frames, cameras etc. The connectivity can use a wireless cellular network such as GPRS or 3G for example, or WiFi, WiMax or similar. The choice of technology will be dependant on both the geography and service contract cost. Suitable ‘off the shelf’ modules for use with the device in order to give it the desired connectivity are available, and the implementation of such connectivity will be readily apparent to those skilled in the art and will not therefore be discussed in more detail.
According to an embodiment, the USB Stick comprises processing capability. The processing element of the stick provides the transparent caching logic, rather than relying on and making assumptions about the host device. According to an embodiment, the cost of the processing unit can be reduced by using a specific implementation (such as an ASIC) rather than a more generic processing unit. Performance and response can be improved through appropriate choice and extension of protocols, e.g. using those which support efficient access to files such as NFS/CFIS rather than those designed purely for transfer such as HTTP/FTP. The stick processor will have responsibility for file system management, including, but not limited to file system exposure (through the chosen exposure technology), USB interface exposure, cache validation, policy validation and data management to/from the central store.

According to an embodiment, a USB memory stick can contain secure storage areas which can be used to store private keys for example. Such keys can be those of the certification authorities that the device trusts for example. Certificates and keys can be device bound, such that they cannot be transferred to any other stick and still be valid. Certificates can be updated in a process orchestrated by the cloud storage service. Certificates and keys provide secure connectivity through, for example, public key cryptography allowing files marked with the appropriate policy to be transferred from the central store to the cache in a secure manner. Secure files are held in an encrypted form on the cache (although not necessarily in the central store) and can require a time limited key for encryption/decryption (for read and write operations). Granting of this key will be based on the device certificate. The device certificate may only be updated from a system administration application and requires the USB stick to be physically connected to the system administration console.

Where appropriate certificates and keys can be used to authenticate and encrypt communication between the stick and the cloud storage service. Certificates can be validated and updated periodically and prior to (and not reliant on) any requests to read data from the device. Certificates can be revoked at any time by the service, effectively rendering content, including that held in the local cache, as inaccessible. Revocation will most likely occur following the loss or theft of a USB stick, however it may also occur when the owner of the stick no longer requires or is permitted access to particular resources store on the device. Revocation occurs in the central service and can be carried out at a resource level (e.g. revoking access to particular files and folders) or at a device level, invalidating access to all secure resources on the device. The cloud storage service can also support multiple sticks accessing the same content, creating a shared collaboration space accessible by a number of users who have a stick. In practice this would require a revision control and concurrency management solution to support multiple accesses to a single resource, and the USB device could be seen as a secure gateway to products and services that already provide this functionality.

The cloud storage service can also support additional processing, for example transcoding/translating file formats (media, documents etc. . . . ) to support display on the multitude of devices that can use the stick. In order for the device and service to identify the capabilities of the host device it will be necessary to obtain a list of capabilities via the USB protocol. Some degree of capability information can be obtained during USB OTG host negotiation, however an extension to the USB protocol can also be used in order to obtain a richer set of metadata. In this case the actual processing (transcoding between different media formats for example) would actually be carried out by the service in the cloud. The USB stick is used purely to determine the capabilities of the host device.

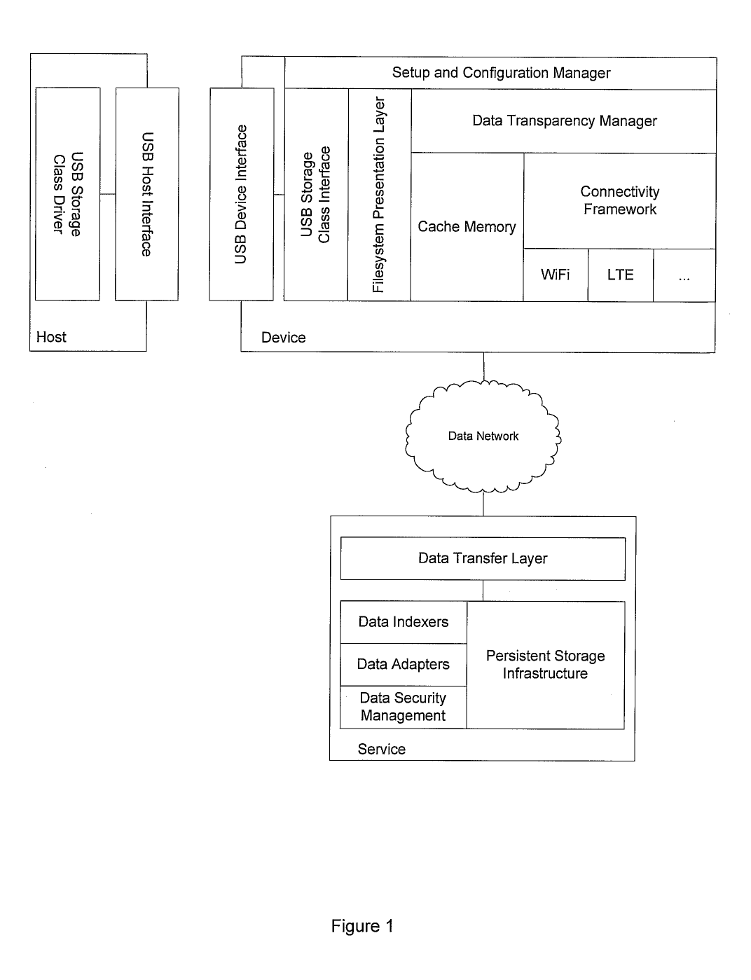

Referring to FIG. 1, there is depicted a schematic representation of software components of a system 100 according to an embodiment. When a device 101 according to an embodiment is engaged with a host device 102, for example using the USB host and device interfaces depicted in FIG. 1, the host device application can request file access (read) or a directory listing.

Upon engagement between the host and the device, USB negotiation and descriptor discovery occurs. The host device determines the type of device which has been connected. According to an embodiment, the device will present itself as a USB Mass-Storage Class device. The host application issues a file access or directory listing request, which is captured and managed by the Filesystem Presentation Layer 103. The Filesystem Presentation Layer validates incoming requests and, if valid (for example, the file/folder exists and permissions allow the requested operation), makes a request for the file data or directory listing from Data Transparency Manager 105. The Data Transparency Manager looks up file data or folder metadata from the onboard cache memory of the device. The Data Transparency Layer 107 validates the file or folder entries against the cache policies. Where the policy identifies that an item or items is no longer ‘fresh’, the Data Transparency Manager 105 uses the Connectivity Framework 109 to retrieve the latest version of the data or metadata from the Persistent Storage Service 111.

The Connectivity Framework 109 retrieves credentials and service endpoint information from the Setup and Configuration Manager 113. The Connectivity Framework determines the most suitable connection medium to use (such as WiFi, LTE, 3G etc. . . . ) and calls the Data Transfer Layer 115 interface from the persistent storage service 111 using the credentials and endpoint returned by the Setup and Configuration Manager 113. The Data Transfer Layer 115 requests file data or folder metadata from the persistent storage infrastructure. The request is validated by the Data Security Manager 117 using the credentials passed from the device.

If required, for file read requests, a Data Adapter 119 translates the source data into a different, previous specified, format. The file data or metadata is collated or streamed (dependent on policy settings, network conditions and device requirements) and returned to the device by the Data Transfer Layer 115.

The Connectivity Framework 109 returns the data, metadata or error code to the Data Transparency Manager 105. The Data Transparency Manager updates the cache memory with the returned data or metadata and returns control flow to the Filesystem Presentation Layer 103. The Filesystem Presentation layer adapts the data or metadata into the specified filesystem format (for example NFS, FAT etc. . . . ). The Filesystem Presentation Layer returns the directory listing or file data in an appropriately formatted response to the Host application via the USB layer 121.

If the host application requests file update (create/write), then, according to an embodiment, the following procedure can be followed:

Providing there is a physical connection and power up between the USB host, then USB negotiation and descriptor discovery can proceed. The host device determines the type of device which has been connected. The device will present itself as a USB Mass-Storage Class device.

The host application issues an update request (e.g. the filename and data), which is captured and managed by the Filesystem Presentation Layer 103. The Filesystem Presentation Layer validates incoming requests and, if valid (the user has permission to perform the requested operation for example), calls the update/create interface in the Data Transparency Manager 105. The Data Transparency Manager updates the file in the onboard cache memory.

The Data Transparency Manager checks the cache policy and will perform one of two actions depending on the broad policy requirements:

i) Write-through cache policy: Changes to the cache must be reflected in persistent storage before control is returned to the host application. If write to persistent storage is not possible then changes to local cache must be rolled back and an error presented to the host application.

ii) Best-efforts cache policy: Control is returned back to the host application as soon as the local cache is updated. File changes are added to a queue which is processed on a best efforts basis. The device will write the changes back to the persistent storage asynchronously.

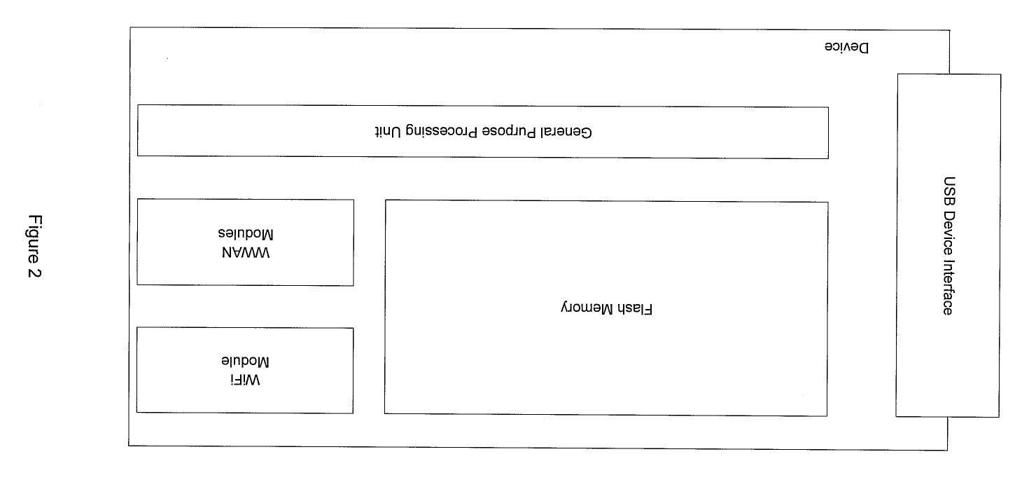

Referring to FIG. 2, there is depicted a schematic representation of hardware components of a device 200 according to an embodiment. The device comprises a USB interface 201, a flash memory module 203, a general purpose processing unit 205, and WiFi and WWAN modules 207, 209.

It will be appreciated that a device according to an embodiment is envisaged as being realised as a USB Stick as this provides common storage analogy for a large number of users and is widely supported by consumer electronics devices. However, this is not intended to exclude the possibility of another form factor and interface implementation, such as SD card, Compact Flash etc.

It is to be understood that the above-referenced arrangements are illustrative of the application of the principles disclosed herein. It will be apparent to those of ordinary skill in the art that numerous modifications can be made without departing from the principles and concepts of this disclosure, as set forth in the claims below.

What is claimed is:

1. A method for executing data access and storage using a host device, the method comprising:
providing a removable device for the host operable to effect communication between the host and a remote storage service, wherein the removable device is operable to cache data received from and sent to the storage service, the removable device further operable to effect communication between the host device and the storage service using a wireless communication module.

2. The method as claimed in claim 1, wherein the removable device further comprises:
a processing module implementing caching logic for the host device for caching data received from and sent to the storage service from the host device.

3. The method as claimed in claim 1, wherein the host device is a device having no or minimal processing capability, and the removable device is operable to retrieve data from and send data to the storage service for the host device.

4. The method as claimed in claim 1, wherein sending and receiving data is performed using the Common Internet File System (CFIS), or the Network File System (NFS).

5. The method as claimed in claim 1, further comprising:
physically engaging the removable device with the host device using a suitable receptacle of the host device such that a local connection between the removable device and the host device is established through which data can be exchanged between the caching logic and the host.

6. A storage device for use with a host device, comprising:
a connection module for effecting a connection between the host device and a remote storage service;
a caching module operable to cache data received from or sent to the storage service using the host device; and
a processing module for providing processing capability for the storage device and host when connected to the host.

7. A storage device as claimed in claim 6, wherein the connection module comprises one or more of a USB connection, a radio-frequency wireless connection module and a cellular network connection module.

8. A storage device as claimed in claim 7, wherein the connection module further comprises a physical connection suitable for engaging with a receptacle of the host device.

9. A storage device as claimed in claim 6, wherein the caching module comprises memory for storing the data, and wherein the processing module is operable to effect communication and transmission of data between the host and the storage service independently of any processing capability of the host device.

10. A storage device as claimed in claim 6, wherein the processing module is operable to effect data transfer to and from the host device to the storage service using any one of CFIS or NFS.

11. A storage device as claimed in claim 8, wherein physically engaging the removable device with the host device using a suitable receptacle of the host device is operable to establish a local connection between the removable device and the host device through which data can be exchanged between caching logic of the removable device and the host.

12. A storage device as claimed in claim 6, implemented in the form of a USB memory stick.

13. A computer-implemented process for effecting the storage and retrieval of data from a storage service for a host device, comprising:
using a removable device, initiating a wireless connection between the host device and the storage service;
using a processor of the removable device, negotiating and effecting the transfer of the data using the storage service for the host device independently of any processing capability of the host device.

14. A process as claimed in claim 13, wherein the removable device has the form factor of a USB memory stick.

15. A process as claimed in claim 13, wherein effecting the transfer of data comprises retrieving data from the storage service for use with the host device, and sending data from the host device via the removable device to the storage service.

16. A process as claimed in claim 15, wherein data retrieved for use with the host device comprises any one or more of audio, video, or image data for playback using a suitable audio or display function of the host device.

17. A computer-implemented process as claimed in claim 13, wherein removable device comprises a physical connection suitable for engaging with a receptacle of the host device.
